(19) United States
(12) Patent Application Publication
(10) Pub. No.: US 2007/0250331 A1
(43) Pub. Date: Oct. 25, 2007

(54) Method for composition of stream processing plans

(75) Inventors: Zhen Liu, Tarrytown, NY (US); Anton V. Riabov, Ossining, NY (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/397,983

(22) Filed: Apr. 5, 2006

(51) Int. Cl. G06Q 10/00; G05B 19/418

(52) U.S. Cl. 705/1; 705/8

(57) ABSTRACT

A computer implemented method, apparatus, and computer usable program code for performing automatic planning in a compositional system. Parameter substitution is performed in response to receiving a planning language input. Actions are preprocessed in response to performing parameter substitution. A backward search is performed for potential solutions in response to preprocessing actions. A domain description is used for performing parameter substitution, preprocessing, and performing a backward search. Actions within the domain description have one or more inputs and one or more outputs. The planning language input specifies at least one goal and at least one action. A description of an action includes at least one description of action preconditions and at least one description of action effects. The action preconditions include predicates that must hold on input streams connected to the action in a valid workflow.

This invention was made with Government support under Contract No. TIA H98230-04-3-0001 awarded by U.S. Department of Defense. The Government has certain rights to this invention.

### BACKGROUND OF THE INVENTION

1. Field of the Invention

The present invention relates generally to stream processing and, in particular, to automatic planning. Still more particularly, the present invention provides a method, apparatus, and program product for composition of stream processing plans in a stream processing environment.

2. Description of the Related Art

Stream processing computing applications are applications in which the data comes into the system in the form of information flow, satisfying some restriction on the data. Note that volume of data being processed may be too large to be stored and, therefore, the information flow must be processed on the fly. Examples of stream processing computing applications include video processing, audio processing, streaming databases, and sensor networks.

In the component based stream processing architectures, the stream processing applications are composed of several processing units or components. The processing units can receive information streams on one or more input ports and produce one or more output streams, which are sent out via output ports. The output streams are a result of processing the information arriving via the input streams, by filtering, annotating, or otherwise analyzing and transforming the information. Once an output stream is created, any number of other components can read data from it. All processing units together compose a workflow. A stream processing application reads and analyzes primal streams coming into the system and produces a number of output streams that carry the results of the analysis.

Primal streams are streams that are received by the stream processing system, but are not generated within the stream processing system. Examples of primal streams include television audio and video information, audio information from a radio broadcast, stock quotes and trades, really simple syndication (RSS) feeds, and the like.

Composing stream processing workflows is a labor-intensive task. This type of task requires that the person building the workflow have an extensive knowledge of component functionality and compatibility. In many cases, this requirement makes it necessary for end-users of stream processing applications to contact application developers each time a new output information stream is requested and, as a result, a new workflow is needed. This process is costly, error-prone, and time-consuming. Also, changes to other elements of the stream processing system may require changes to the workflow. For example, processing units or primal streams may become unavailable, users may place certain restrictions on the output, or changes may be made to the components themselves.

In large practical stream processing systems, both changes in the data coming into the system and changes in the system configuration can invalidate deployed and running stream processing applications. With time, these applications can start to produce output that no longer satisfies the user's requirements or they may rely on primal streams that have become inactive or some additional system changes, such as adding new hardware or new components/processing units, may have occurred. In many situations, user's requirements can be better satisfied if an existing workflow is updated with newly available primal streams or components/processing units. Therefore, when changes occur such as those described above, the workflow must be reconfigured quickly before any potentially valuable streaming data is lost. Such timely reconfiguration is extremely difficult to achieve if the workflow composition requires human involvement.

Similar workflow composition problems arise in web services and grid computing. Existing standards, such as OWL-S, provide methods and data structures for describing the functionality of web service components, referred to as services. The interaction between the components in web services may be more general than those in stream processing systems, and may take form of request and response interaction instead of acyclic information flow.

Finding an optimal or even a feasible plan for planning problems is extremely difficult. Plans for producing solutions for stream processing systems often increase exponentially when the number of components increases linearly. However, solving this problem is importance in practice, and the worst case performance is not always an issue in practical use of stream processing planners. Therefore, it would be advantageous to have a method and apparatus for finding an optimal plan that works efficiently and scale well on instances that are most likely to appear in practice.

### SUMMARY OF THE INVENTION

The aspects of the present invention provide a computer implemented method, apparatus, and computer usable program code for performing automatic planning in a compositional system. Parameter substitution is performed in response to receiving a planning language input. Actions are preprocessed in response to performing parameter substitution. A backward search is performed for potential solutions in response to preprocessing actions. A domain description is used for performing parameter substitution, preprocessing, and performing a backward search. Actions within the domain description have one or more inputs and one or more outputs. The planning language input specifies at least one goal and at least one action. A description of an action includes at least one description of action preconditions and at least one description of action effects. The action preconditions include predicates that must hold on input streams connected to the action in a valid workflow. The action effects include creation of new streams that include an action output. The description of the action effects include information for computing predicates on output streams given predicates on input streams.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 illustrates an architecture for automatic composition of stream processing workflows satisfying output requirements expressed by end users or systems in accordance with an exemplary embodiment of the present invention;

FIG. 4 illustrates an example of a stream processing workflow in accordance with exemplary aspects of the present invention;

FIG. 5 illustrates an example of stream processing in accordance with exemplary aspects of the described embodiments;

FIG. 6A-6F illustrates example stream processing planning data structures in accordance with an exemplary embodiment;

FIG. 7A-7B is an illustrative outline of the structural hierarchy of object containment used in an automated planning system for stream processing workflow composition in accordance with an exemplary embodiment of the present invention;

FIG. 8 is a flowchart illustrating operation of an automated planning system for stream processing workflow composition in accordance with an exemplary embodiment;

FIG. 9 is a flowchart illustrating simplification and preliminary analysis performed during preprocessing in an automated planning system for stream processing workflow composition in accordance with an exemplary embodiment;

FIG. 10A-10B is a flowchart illustrating a backward search in an automated planning system for stream processing workflow composition in accordance with an exemplary embodiment;

FIG. 11 is a flowchart for processing candidate inputs that are actions in an automated planning system for stream processing workflow composition in accordance with an exemplary embodiment;

FIG. 12 is a flowchart for processing candidate inputs that are fully specified streams in an automated planning system for stream processing workflow composition in accordance with an exemplary embodiment; and

FIG. 13 is a flowchart for processing candidate inputs that are partially specified stream in an automated planning system for stream processing workflow composition in accordance with an exemplary embodiment.

### DETAILED DESCRIPTION OF THE PREFERRED EMBODIMENT

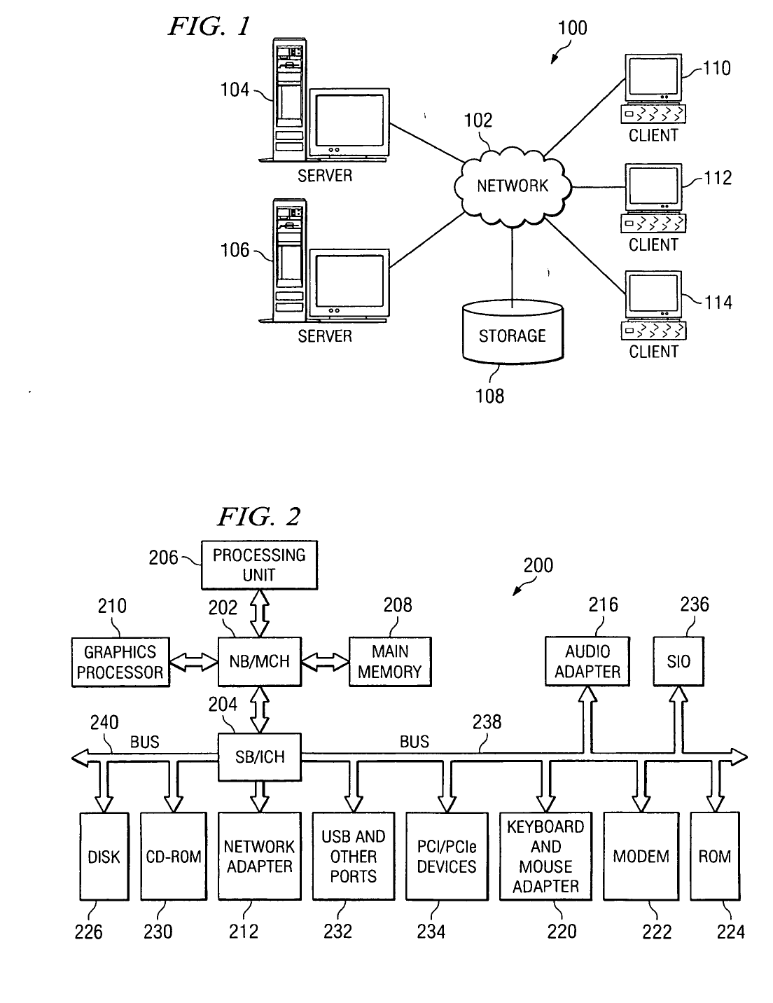

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

FIG. 1 is a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In an exemplary embodiment, server 104 may provide stream processing applications to clients 110, 112, and 114. Clients 110, 112, and 114 are clients to server 104 in this example. Network data processing system 100 may include additional servers, clients, and other devices not shown.

In one exemplary embodiment, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

Local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (JAVA is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Aspects of the present invention provide a process of automatically creating workflows based on a formal description of processing units, primal streams and user's requirements on the output data. The process is able to quickly adapt to newly available primal streams, processing units, and other changing parameters, circumstances, or conditions without unduly burdening system resources and without human interaction.

Additionally, the workflow may be translated into a format that may be executed in a web services execution environment.

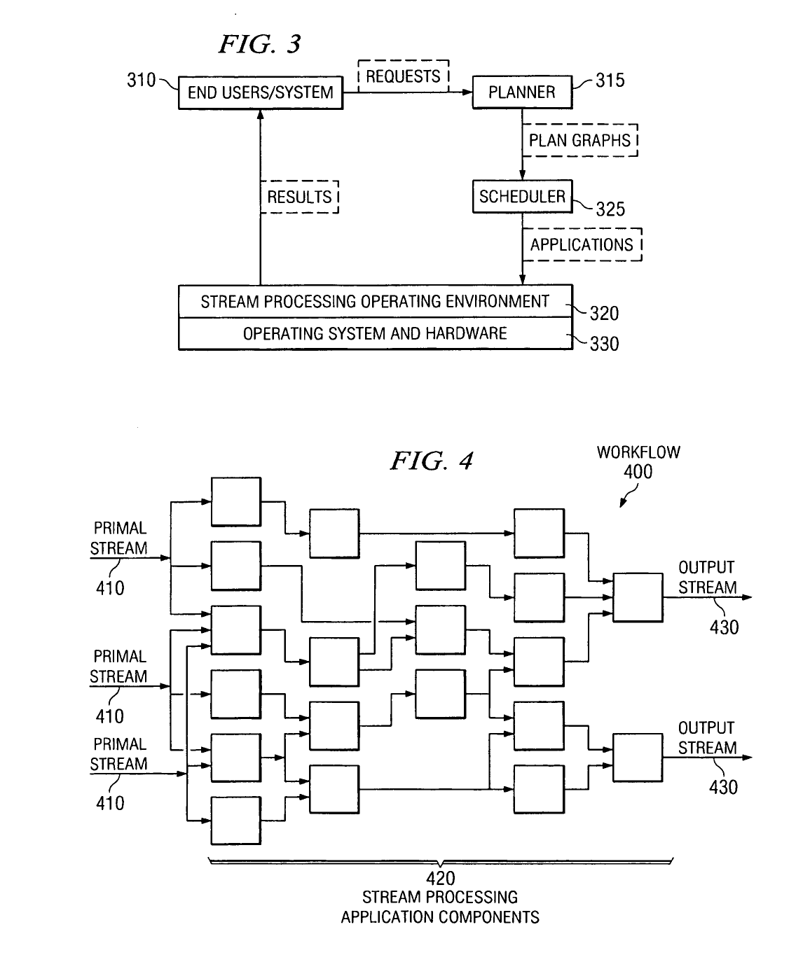

FIG. 3 illustrates an architecture for automatic composition of stream processing workflows satisfying output requirements expressed by end users or systems in accordance with an exemplary embodiment of the present invention. In applying artificial intelligence automatic planning techniques, the system describes the initial state, the goal state, the conditions for applying each of the possible actions to the states, and the effects of each action. This description may be done using a predicate-based description language. The plan is defined as a sequence of actions that lead from the initial state to a state that satisfies all goal requirements.

Latest advances in artificial intelligence planning started with the application of plan graph analysis methods to planning. Application of plan graph analysis essentially increased the size of planning problems that can be solved by automatic planners. Further development of automated planning systems was stimulated by introduction of a standard for the description language for planning domains and planning problems. Planning is an important aspect of the autonomic computing model, and it has always been considered as part of the autonomic monitor-analyze-plan-execute using knowledge (MAPE-K) loop.

Recognition of the application of automatic planning to stream processing workflow composition is an important aspect of the present invention. Referring again to FIG. 3, end users/systems 310 provide requests to planner 315. The requests are goal-based problems to be solved by planner 315, which then generates plan graphs to execute in the stream processing operating environment 320. Scheduler 325 deploys and schedules stream processing applications for execution within stream processing operating environment 320 on top of operating system and hardware 330. Stream processing operating environment 320 then returns the results to end users 310.

FIG. 4 illustrates an example of a stream processing workflow in accordance with exemplary aspects of the present invention. Workflow 400 receives as input one or more primal streams 410. A stream represents a flow of information satisfying certain restrictions or constraints. An example of the stream data may be a sequence of n-tuples of a predefined format. Primal streams 410 are streams that are received by the stream processing system, but are not generated within the stream processing system. Examples of primal streams include television audio and video information, audio information from a radio broadcast, stock quotes and trades, really simple syndication (RSS) feeds, and the like.

Stream processing application components 420 are configured to receive, analyze, and/or transform primal streams 410 to form resulting output streams 430. Stream processing application components 420 may be reusable components that perform stream processing functions. Examples of stream processing application components 420 include, but are not limited to video processing, image analysis, speech-to-text conversion, text analytics. Each one of stream processing application components 420 may have one or more inputs and one or more outputs.

The number of possible primal streams within primal streams 410 is enormous. Since stream processing application components 420 are preferably reusable software components, they may be configured and reconfigured into many different workflows to form a seemingly limitless number of stream processing applications. Also, the workflows may become very complex. For example, a given workflow may use tens of primal streams and include hundreds, if not thousands, of application components. To generate such a workflow by hand, and on demand, would be quite challenging if not simply impracticable. In fact, it is even difficult to know all possible components and their parameters, much less to be able to combine them into an effective workflow that satisfies all of the user's requirements.

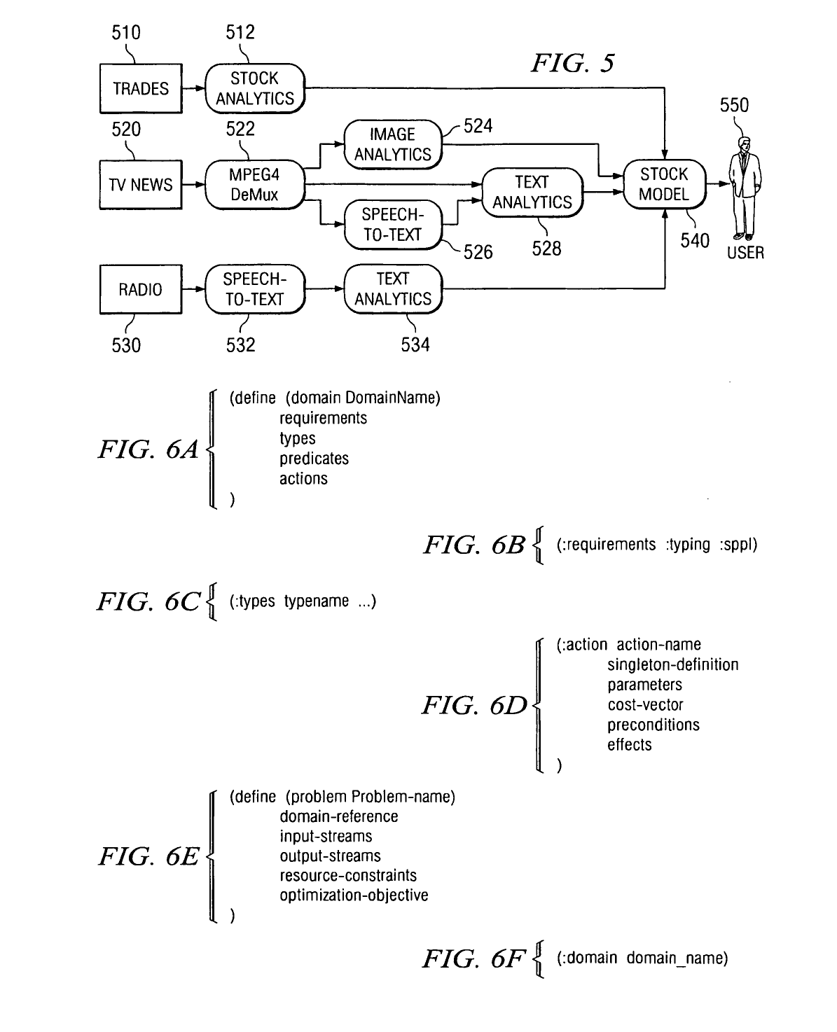

FIG. 5 illustrates an example of stream processing in accordance with exemplary aspects of the described embodiments. In this example, user 550 requests to be notified when a particular stock is likely to exceed a predetermined value. In these illustrative examples, primal streams or broadcast streams include trades 510, television news 520, and radio 530. In the depicted example, application components include stock analytics 512, moving pictures experts group 4 (MPEG-4) de-multiplexer 522, image analytics 524, speech-to-text 526, text analytics 528, speech-to-text 532, text analytics 534, and a stock model 540.

A stream processing application may be composed from existing application components, using available primal streams, such that the application components generate a result that satisfies the user's request. Thus, stock analytics 512 receives an information stream, trades 510 and outputs results to stock model 540.

MPEG-4 de-multiplexer 522 receives a broadcast stream, television news 520 and outputs to image analytics 524, text analytics 528, and speech-to-text 526. Speech-to-text 526, in turn, outputs to text analytics 528. Image analytics 524 and text analytics 528 output to stock model 540.

Speech-to-text 532 receives a primal stream, radio 530 and outputs to text analytics 534. In turn, text analytics 534 outputs to stock model 540. Stock model 540 provides output to user 550.

For stream processing workflow composition with automatic planning, the following formal definitions are provided:
1. A data structure for describing stream content.

This data structure specifies values of predicates about certain properties of the stream, as well as certain properties and other types of descriptions. An example of a property is “video of type MPEG-4.” A numeric property may be, for instance, “throughput=10 KB/s.” This structure may be referred to as stream properties.
2. An instance of stream properties structures is created and initialized with appropriate values for each primal stream.
3. A formal description for each stream processing component. Each description includes:
   a. Definition of one or more input ports, where each input port defines the conditions under which a stream can be connected to the input port. In programming, a predicate is a statement that evaluates an expression and provides a true or false answer based on the condition of the data. These conditions are expressed as logical expressions in terms of stream properties. For example, a stream of type “video” may be required on one port of a stream processing component, and a stream of type “audio” on another.
   b. Definition of one or more output ports, where each output port definition describes a formula or a method for computing all properties of the output stream, possibly depending on the properties of all input streams connected to the component.
4. Part of each end user's request for stream processing (goal) is translated to a formal logical expression in terms of stream properties that must be satisfied by the property values associated with the output stream, or multiple output streams if multiple goal definitions are given.

Given the above problem definition, where metadata descriptions 1-3 are referred to as a “planning domain” and 4 is referred to as the “planning problem,” the planning algorithm can compute properties of any stream produced by a component or a combination of components applied to primal streams, and verify whether goal requirements are satisfied. For example, the method of exhaustive search (depth-first or breadth-first) may be used to find a workflow that produces streams satisfying goal requirements. In some systems, it is important to find workflows that not only satisfy the goal, but also satisfy additional criteria, such as optimal quality or optimal resource usage. The same exhaustive search method, or more efficient methods, may be used to achieve these objectives.

In one embodiment, the formal description of the workflow composition problem defined above may be encoded using planning domain definition language (PDDL), and submitted to a planning system, such as LPG-td, Metric-FF, or any other known planning system. LPG (Local search for Planning Graphs) is a planner based on local search and planning graphs that handles PDDL2.1 domains involving numerical quantities and durations. The planning system can solve both plan generation and plan adaptation problems. LPG-td is an extension of LPG to handle the new features of the standard planning domain description languages PDDL2.2. Metric-FF is a domain independent planning system developed by Jorg Hoffmann. The system is an extension of the FF (Fast-Forward) planner to handle numerical state variables, more precisely to PDDL 2.1 level 2, yet more precisely to the subset of PDDL 2.1 level 2 with algorithmic principles.

In one embodiment, stream properties may be encoded as fluents and predicates parameterized with a stream object. In programming, a predicate is a statement that evaluates an expression and provides a true or false answer based on the condition of the data. These conditions are expressed as logical expressions in terms of stream properties. A fluent is a more general function then the predicate. Fluents may take values from domains other than the Boolean domain of the predicates. Fluents are also referred to as functions in literature. Component descriptions are encoded as actions parameterized with input and output stream objects. Preconditions of actions consist of translated input port requirements on input streams and action effects compute the properties of output stream objects with the transformation formulas associated with output ports. A plan generated by the planning system as a sequence of actions is then translated into a workflow by identifying input-output port connections based on the sharing of stream objects between instantiated action parameters corresponding to the port.

However, trying to implement automatic planning for stream processing workflows using planning domain definition language (PDDL) presents several difficulties. The fact that a given stream contains some predicates and that the number of streams is restricted only by equivalence relations, dictates that a lot of space is required to describe all possible streams. An action of a component with multiple inputs and outputs cannot be effectively decomposed into a set of actions with conjunctive form of conditional effects. Again, to accurately represent stream processing components requires an enormous amount of space.

Therefore, in one exemplary embodiment, an enhanced description language is provided. A stream processing planning language (SPPL) builds on the planning domain description language to address the special needs of stream processing workflow planning. Following is a description of the extensions to the description language for stream processing workflow planning.

The “stream” algorithm can quickly establish connections between the actions directly, without assigning intermediate stream variables. The general-purpose planners, in contrast, do not have the knowledge of workflow structure and must spend a considerable amount of time on evaluating different stream variable assignments. The workflow domain structure is made explicit to the solver by formulating the planning problem in stream processing planning language (SPPL), which is described in further detail below. A primary difference of SPPL from PDDL is in allowing actions to work with multiple inputs and multiple outputs, and in allowing multiple inputs to be connected to the same output. In a planning domain definition language model of the planning task, actions modify the state of the world, and it is assumed that after an action is applied, the state changes. In contrast, when stream processing planning language actions are applied, the new state after the action is applied will differ from the state before only by new streams that have been created. All the streams that existed in the old state will still exist in the new state. Input ports of any actions may be connected to any stream available in the state to which the action is applied. With this change, stream processing planning language model can easily express workflow planning problems where multiple streams must be created, and therefore multiple data goals must be achieved simultaneously, or the problems where stream processing components have multiple inputs. Both of these scenarios require multiple streams, and therefore multiple descriptions of streams by predicates, to exist at the same time.

The following features of PDDL are preserved in SPPL:
Single input and single output actions can be used to model all PDDL concepts related to classical planning. These concepts include preconditions, add and remove lists of predicates, predicate parameters, conditional effects, etc.
The same features can be used on each input and each output of an SPPL action, similarly to current usage on single input and single output of PDDL actions.
SPPL actions can be parametric.
The language can allow the definition of numerical functions, and corresponding numerical effects and preconditions for actions, as well as optimization and constraints on the value of these functions.
   SPPL adds to PDDL the following unique features:
At each planning stage, the state of the world consists of a set of available streams. Each stream is described by a set of stream fluents, or predicates. The sets of state variables are the same across all streams; however, the values can be different.
Initial state of the world represents a set of primal streams available for processing. Each stream is described by its state, for example, values assigned to state variables.
Planning goal describes a set of streams, where for each stream constraints on state variables are specified.
Once a stream is created, the predicates associated with the stream are never changed, and the stream is available to all subsequent actions as input.
Multiple outputs are described by multiple effects produced simultaneously by an action. Each effect corresponds to creation of a new stream, and does not modify any of the existing streams.
Multiple inputs are described by multiple preconditions required by the action. Each precondition expresses requirements on one input stream, which are connected to the corresponding port.
For convenience of expressing solutions, preconditions and effects may have names, which are also referred to as input and output names, respectively. After planning completion, the workflow (stream processing plan) is described by listing the action instances used in the workflow (one action may correspond to more than one instance) and links between effects and preconditions. The names are used in link descriptions to specify to which one of several effects and preconditions a link is connected to.

Within the scope of this disclosure, the goal is not to propose any specific syntax for the language, but rather to describe a plan composition methods incorporating concepts and data structures used for describing workflow planning problems. This description does not include examples of using conditional effects, functions, or fluents. These extensions can be naturally added to the language, since it is very similar to PDDL, and syntax and semantics will be the same, with the exception that all effects are applied to merged streams.

Stream merging is an operation unique to SPPL. In PDDL, an effect describes modification to world state made by the action. Since an SPPL action may receive many states (states of all input streams connected to the action), if the effects were to be specified similarly to PDDL, the states of input streams are merged to form a single state, to which the effect is applied following PDDL definition of action effects. The merging rules can differ.

In one exemplary implementation, three groups of state variables are defined: and-logic, or-logic, and clear-logic. For each of the groups, a unique merging rule is used. Predicates defined in and-logic rule are combined using a logical AND operation. For example, if and-logic predicate A is true in the state of input streams 1 and 1, but not in 3, the value of A in the merged state will be false. The or-logic predicates are combined using a logical OR operation. In the same situation as described above, the value of A would be true if A were an or-logic predicate. Clear-logic predicates always have a merged value of false.

FIGS. 6A-6F illustrate example stream processing planning data structures in accordance with an exemplary embodiment. More particularly, FIG. 6A illustrates an example data structure for a domain definition. The domain section is enclosed in a domain definition statement. The requirements, types, predicates, and actions are defined similarly to domain definition by specifying lists enclosed in parentheses. A domain definition alone does not constitute a planning problem. Both problem and domain definitions are supplied to the solver in order to obtain a plan.

A requirements list is provided for backward compatibility only. FIG. 6B depicts an example data structure for a requirements list only one requirements section can be present in a domain definition. The requirements section describes file format and is optional.

A types section lists the names of the enumeration types used to define predicate parameters. Each predicate parameter is a variable of one of the types defined here. The set of possible constant values of each type listed here are defined in the objects section of the problem definition.

At most, one types section can be present. If the propositional formulation is used, types section can be omitted. The planner may convert predicate formulations to propositional formulations during preprocessing. Therefore, propositional formulations are preferred to predicate formulations from an efficiency point of view, although both formulation types can be handled by the solver.

FIG. 6C depicts an example data structure for a types section of the domain definition. The list start with :types declaration, and then the type names follow. Below is an example:

(:types

tag
full_name
age_group

)

A predicates section defines a group of predicates. Each group consists of an optional logic type specification and one or more predicate declarations. Each predicate declaration may also specify parameters for the predicates. For each parameter, the type is specified.

All predicates within one group are assumed to follow the same input merging rules. The available choices are :andlogic, :orlogic, and :clearlogic. Only one of these merging operation types can be specified within one group. For backward compatibility with PDDL, if the merging operation is not specified, :andlogic is assumed.

Predicate group declaration starts with :predicates, followed by an optional merging operation identifier, and then by a list of predicate declarations. Each predicate declaration is a name of a predicate, possibly followed by parameters. Each parameter consists of a definition of a formal parameter starting with a question mark “?”, and the type of the parameter separated from formal parameter by a dash “-”.

Multiple groups can be defined within one domain. Defining more than one group with the same merging type is not prohibited. At least one group of predicates is defined in each domain. The following is an example of a predicate group declaration:

(:predicates :andlogic

(video_stream)
(audio_stream)
(contains ?t - tag)
(filtered_by ?n - full_name ?a - age_group)

)

FIG. 6D illustrates an example data structure for action definition. An action definition describes a processing component and consists of one action name, one singleton definition, one declaration of formal parameters, one resource cost vector, one or more preconditions, and one or more effects. Multiple action definitions are allowed in each domain. Each action has a name, at least one precondition entry, and at least one effect entry.

An action singleton definition specifies that only a single action instance should be used in the workflow. This declaration is optional and is only included in the declaration of operators that should only be used once in the plan. Below is an example:

(:action SourceN1

:singleton
. . .

)

Action parameters are defined in the same manner as in PDDL. An example of a data structure for parameters definition is as follows:
:parameters (?t-type)

A cost vector definition is an additive resource cost vector corresponding to the action. A cost vector definition is an optional element. At most one cost vector definition is allowed. The costs are used for computing optimization objective and for specifying constraints. All cost vectors are added across all action instances in the workflow before the objective is computed or constraints are verified. An example of a cost vector definition is as follows:
:cost (10 2 13.2)

A precondition definition for an action follows the same syntax as STRIPS PDDL, except that multiple preconditions corresponding to different input ports can be specified, and for each port the port name can be defined. Below is an example of a precondition definition for an action:
:precondition [in1] (and (P0 ?t) (P1))

An effect definition for an action follows the same syntax as STRIPS PDDL, except that multiple effects corresponding to different output ports can be specified, and for each port, the port name can be defined. The following is an example of an effect definition:
:effect [ou1] (and (P4 ?t) (not (P0 ?t)))

The following is an example of an action definition with parameters, cost vector, preconditions, and effects:

(:action A
:parameters (?t - type)
:cost (10 2 13.2)
:precondition [in1] (and (P0 ?t) (P1))
:precondition [in2] (and (P0 ?t) (P2))
:effect [ou1] (and (P4 ?t) (not (P0 ?t)))
:effect [out2] (and (P5) (P4 ?t) (not (P0 ?t)))
)

FIG. 6E illustrates an example data structure for a problem definition. A problem definition consists of a problem name, a reference to the corresponding domain, the list of objects for each of the declared types, definitions of input streams and goals for output streams, resource constraints, and objective specification. A domain reference specifies the domain used in the problem definition. FIG. 6F illustrates an example data structure for a domain reference. The domain reference is a required element, exactly one domain reference is specified in these examples. The referenced domain is defined in the input to the solver; otherwise, the solver will fail.

Object definitions follow the same syntax as STRIPS PDDL object definitions. For each object, a type is defined. Following is an example of an objects definition:
(:objects
com-ibm-distillery-sandp-labels—type_name
com-ibm-distillery-VEHICLE—type_name
com-ibm-distillery-BODYPART—type_name)

Input streams definitions follow the same syntax as STRIPS PDDL init (a list of ground predicates). However, unlike in PDDL, multiple inits can be specified, each corresponding to a separate input stream. Output streams (goals) definitions follow the same syntax as STRIPS PDDL goal (a list of ground predicates). However, unlike in PDDL, multiple goals can be specified, each corresponding to constraints on a separate output stream.

Resource constraints are specified with a double vector, establishing the component-wise upper bound on the sum of resource requirement vectors for all action instances used in the plan. The definition starts with a :bound keyword, followed by a list of double values for the vector. Only a single resource constraints entry is allowed. If the constraints are not specified, the one-dimensional vector will be used.

In PDDL, a similar statement can specify more general constraints on functions, such as >, >=, <, <=, =, comparing to another function, expression, or constant. An example is as follows:
(>=(function1)(function2))

An optimization objective may be specified by a double vector of coefficients. The object vector is multiplied by the sum of resource vectors of all action instances included in the workflow to compute the objective value for minimization. Only one objective can be specified. If no objective is given, then a constant one-dimensional vector (1) is used.

In PDDL, a similar statement can be used to specify an expression to use as an optimization metric expression using a (:metric) statement, such as (:metric minimize (function1)).

Below is an example of an optimization objective in SPPL:
(:objective 1.0 0 0)

The planning device, also referred to herein as the planner or solver, finds an optimal or close to optimal valid plan. Validity of a plan may be verified by forward predicate propagation procedure, which computes stream properties starting from primal streams used in the plan.

The computation of predicates starts with the source streams, for which all ground predicates that are true on the stream are listed in the corresponding (:init) statement. In general, the values of the predicates defined on the streams produced by actions depend on the values of the predicates with the matching names and parameters defined on the streams connected to the input ports of the action. Since the planned workflow is a directed acyclic graph of action instances connected by streams, an automatic procedure can be used to compute the values of predicates on every stream, starting from the sources and reaching the goal, action by action, processing each action once until all input stream predicates for the component are defined. Actions are models of the components in a stream processing planning language representation of the planning problem.

The planned workflow contains action instances, in which values for all parameters are given, and all predicates are ground. If the action is declared using :singleton declaration, at most one instance of the corresponding action can be used in a valid plan. In a valid workflow, the input streams connected to each action satisfy the corresponding input port precondition. All predicates listed in the precondition must be true on the corresponding stream. The goal conditions, similarly, must be satisfied by the corresponding outgoing streams of the workflow.

The value of a ground predicate p(x[1],x[2], . . . ,x[k]) on an output stream is always true if the corresponding effect of the action instance contains the same ground predicate, and is always false if it contains the negation of this predicate, i.e. (not p(x[1],x[2], . . . ,x[k])). Otherwise, the value is determined as follows:
If predicate p( ) is declared in :clearlogic group, its value in the output stream will always be false, unless it is defined by the effect of an action instance as specified above.
If predicate p( ) is declared in :andlogic group, its value is equal to true if and only if the predicate with the same name and parameters is true on every input stream connected to the action instance, unless it is defined by the effect of an action instance as specified above.
If predicate p( ) is declared in :orlogic group, its value is equal to true if and only if the predicate with the same name and parameters is true on at least one input stream connected to the action instance, unless it is defined by the effect of an action instance as specified above.

The metrics of the plan are computed using a resource vector. The value of the resource cost vector for the workflow is equal to the sum of constant resource vectors specified for every action instance used in the workflow. If the same action corresponds to more than one instance in the workflow, the cost vector of the action is added to the total resource vector as many times as there are instances. For valid plans, the resulting total cost vector does not exceed (component-wise) the bound vector, if the bound vector is specified in a :bound statement.

If an (:objective) statement is used to specify the objective vector, c, then the plan constructed by the planner achieves the minimum value of scalar product c′x, where x is the total cost vector of the plan, among all feasible plans. It is allowed for the planning device to produce suboptimal plans if they have close to optimal objective values.

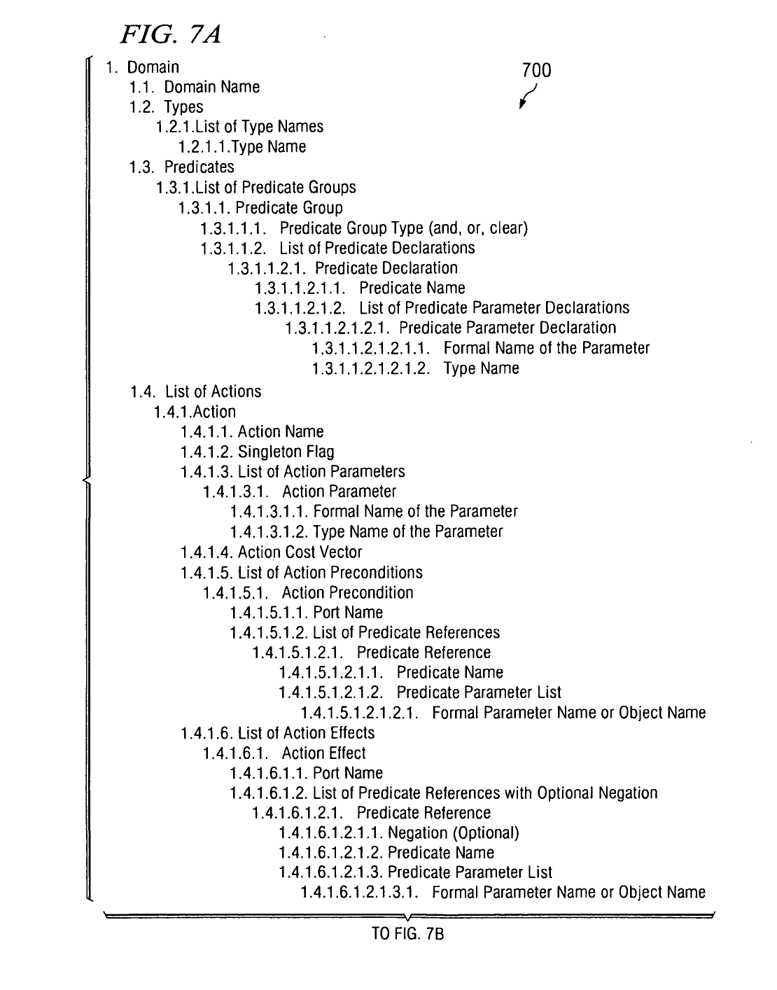

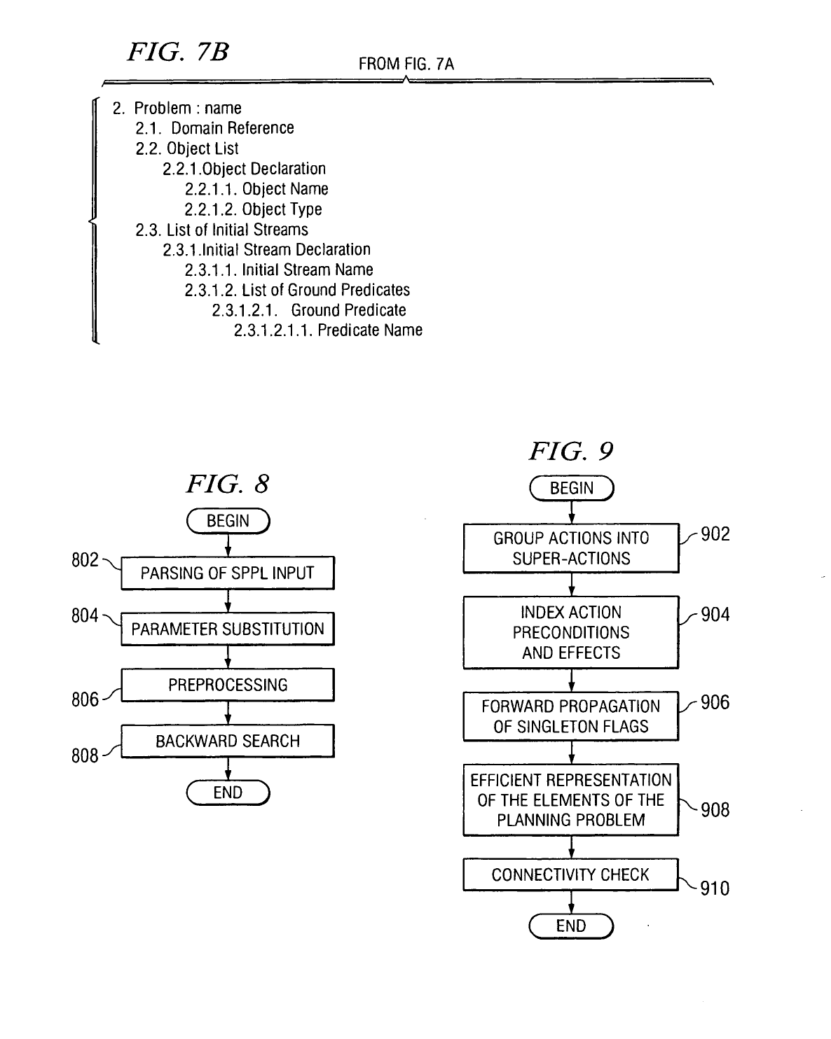

FIG. 7A-7B is an illustrative outline of the structural hierarchy of object containment used in an automated planning system for stream processing workflow composition in accordance with an exemplary embodiment of the present invention. Object hierarchy 700 of FIG. 7A-7B conforms to the structure defined in FIGS. 6A-6E. Object hierarchy 700 of FIG. 7A-7B may be used by a planning library, solution component or planner, such as planner 315 in FIG. 3. The representation of FIG. 7A-7B includes object hierarchy 700 following stream processing planning language (SPPL) syntax that may be used for parsing of stream processing planning language input. Parsing of stream processing planning language input creates in-memory representation corresponding to the domain description and problem description.

Stream processing planning language (SPPL) is a description language for stream processing workflow planning based on planning domain definition language (PDDL). Object hierarchy 700 is a data structure or representation of a stream processing planning language domain and a problem in computer memory.

FIG. 8 is a flowchart illustrating operation of an automated planning system for stream processing workflow composition in accordance with an exemplary embodiment. The process of FIG. 8 may be implemented in a planner such as planner 315 of FIG. 3. The process of FIG. 8 describes a process for performing a backward search, executed in sequence. This search is used to build a graph of actions starting from the result that is to be produced. The process begins by parsing the stream processing planning language input (step 802). The planner performs parameter substitution (step 804). During parameter substitution actions are grounded by substitution of all possible combinations of objects for action parameters. Next, the planner performs preprocessing (step 806). Preprocessing of actions in step 806 creates a new representation of the planning model. Within that new representation a single action may represent a group of actions of the original model. Additionally, duplicate actions may be eliminated and assignments of each action may be refined. The planner searches backward (step 808) with the process terminating thereafter.

Steps 804-808 receive input from the previous step, in a form that is specific to that step. As a result, three different formulations for solving the problem are created during the last three steps. The search of step 808 is performed based on the last formulation created. The solutions or set of solutions is refined as constructed from the last formulation.

Stream processing planning language input is parsed in step 802 to create in-memory representation corresponding to domain and problem description.

During parameter substitution (step 804), actions are grounded by substitution of all possible combinations of objects for action parameters. Reachability analysis methods may be used during step 804 to consider potentially reachable assignments of action parameters in order to reduce the overall number of actions created. Ground actions are also referred to as operators. All predicates used in the stream processing planning language file also become ground during step 804.

Each of the ground predicates used in problem formulation is added to one of three arrays, such that each predicate appears with a particular set of actual parameters at most once in one of the arrays. All ground predicates corresponding to the same predicate, but with different parameter sets, appear within the same array. One array is defined for each type of predicate group and the ground predicates may be added to arrays corresponding to their group. For example, the predicate group may include AND, OR, or CLEAR logic. Parameter substitution (step 804) allows the algorithm to replace all references to ground predicates in operators by their respective index in the array. If the array reference, for example, predicate group type, is preserved, the index may be traced back to the original ground predicate. The grounding actions of step 804 are particularly different from other planners and planning languages because of the assignment of predicates to one of three groups, AND, OR, and CLEAR, which are specific to stream processing planning language.

During the procedure of grounding actions in step 804, the ground predicates that are specified as effects or initial conditions, but never referred to in preconditions or goal statements, may be removed. Similarly, the operators may be removed if they contain preconditions with one or more ground predicates which are not included in any effect of some other operator, or in one of the init statements. Init statements are a list of ground predicates.

FIG. 9 is a flowchart illustrating simplification and preliminary analysis performed during preprocessing in an automated planning system for stream processing workflow composition in accordance with an exemplary embodiment. The process illustrated in FIG. 9 may be implemented in a planner, such as planner 315 in FIG. 3. The process depicted in FIG. 9 is a more detailed description of preprocessing actions in a step such as step 806 in FIG. 8.

The process begins as the planner groups actions into super-actions (step 902). Actions that have exactly the same input and output port descriptions are combined to form super-actions. The actions corresponding to one super-action differ only in cost vectors and names, and have the same preconditions and effects. For faster processing, step 902 is performed after the preconditions and effects have been indexed because the index significantly increases the speed of finding actions that belong to the same group.

The preprocessing state creates a new representation of the planning model. Within that new representation a single action may represent a group of actions of the original model. For example, a single super-action may represent a group of actions. The plans constructed for this modified model need further refinement to determine exact assignment of actions. Each super-action included in the plan is replaced by one of the actions from the group. Computing this assignment is based on the cost vectors of the actions.

The optimization problem of finding best action assignment to the super-actions in the plan subject to cost bound and with objective optimization is significantly easier to solve than the general planning problem. Various methods may be used to build approximate solutions. For example, grouping of the actions, and approximations based on dynamic programming may be used to approximate solutions. Other approximation methods not specifically directed toward dynamic programming may be used. Additionally, other approximation methods that combine dynamic programming with other methods, such as sorting and rounding, may be used for finding approximate solutions to the multiple choice knapsack problem. Grouping actions into super-actions may also be performed before grounding in a step such as parameter substitution step 804 of FIG. 8.

Next, the planner indexes action preconditions and effects (step 904). To improve search speed, the planning process uses an index of candidate actions inputs for each output, and candidate outputs for each input. Since the values of predicates in the CLEAR group are defined independently of preceding actions, these predicates are used to decide whether an input port and output port may be compatible, and therefore are candidates for each other. If the add-list in the CLEAR group of the effect defined on the output port is a subset of the CLEAR group of the precondition on the input port the two groups may be compatible.

Other conditions that may be tested during initial compatibility check to reject candidates that may never be connected include checking the delete-list of the output for intersections with the precondition for the input. Initial states and goals are also included in the index, as are outputs and inputs correspondingly.

Index action preconditions and effects (step 904) is an optional step. In some embodiments step 904 improves search time by reducing search space, and other preprocessing steps may be implemented more efficiently.

Next, the planner forwards propagation of singleton flags (step 906). In stream processing planning language, an action can be declared as a singleton, meaning that at most one instantiation of this action is needed in a feasible plan. However, an action is a de-facto singleton if in the state space there can exist only one set of input vectors for this action. For example, an action is a de-facto singleton if only one vector exists for each input port of the action. Multiple instantiations of such an action in the plan will not create new vectors, and therefore creating more than one instantiation is wasteful.

The de-facto singletons are detected by using the index of preconditions and effects and tracing back from action inputs to the initial conditions to find whether there exists more than one possible path or subplan producing the resulting action. If at some point during this tracing more than one candidate output is found for one of the action inputs, the path is not unique, and the action is not a de-facto singleton. However, if the inputs are traced back to initial streams, or other singletons, and no alternative candidates are encountered, the action is a de-facto singleton, and is marked with a singleton flag, as a regular user-defined singleton. During step 908 the planner will create at most one instantiation of an action marked with this flag within a plan. In some embodiments, step 906 is an optional step.

Next, the planner performs efficient representation of the elements of the planning problem (step 908). During preprocessing efficient representation of stream state vectors is used to describe preconditions and effects. The CLEAR group of the add-list of the effect of the action is always equal to the corresponding group in the state of the stream assigned to action output. Therefore, the state of each stream is represented by a data structure that may be decomposed by groups, and the value of each group may either be specified explicitly, or by reference to another stream state description. This allows the use of pointers instead of copies for constant CLEAR groups when stream state is computed during search.

During search, the state of each stream created in the plan is described by a set of predicates. Since predicates may be enumerated, it is possible to represent a stream state as vector, where each element has value of 0 or 1, and corresponds to a predicate. One embodiment allows switching between vector representation and set representation. For example, one embodiment has been used to find that vector-based implementation works 10%-50% faster for small number, such as less than 200, predicates.

Next, the planner performs a connectivity check (step 910). The index of candidate inputs and outputs also enables the planner to quickly verify whether the graph formed by connecting all actions with directed links corresponding to candidate connections is such that for each goal there exists at least one directed path in that graph that connects one of the initial streams to the goal. If for one of the goals there is no such path, there are no solutions to this planning problem. In some embodiments, step 910 is optional.

Optionally, shortest path computation may also be used here to verify whether resource bounds on each of the resources may be reached. To verify whether resource bounds may be reached, resource costs of all actions are positive. For this computation the weight of all input links for each action should be set to the value of resource cost of the action in the selected dimension.

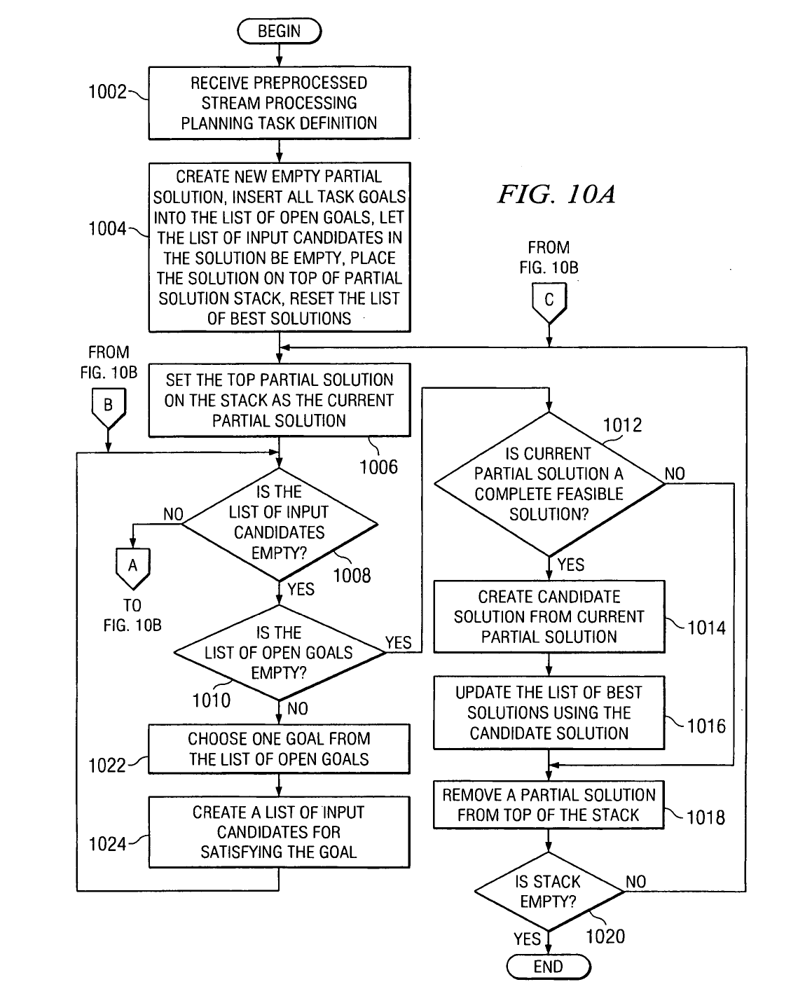

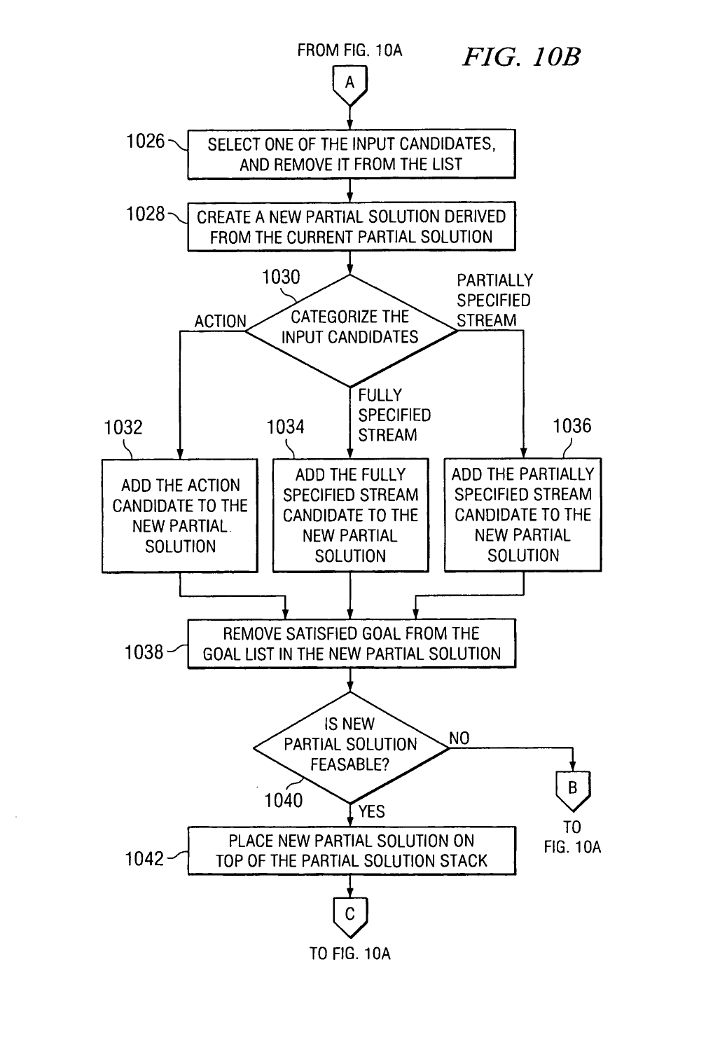

FIG. 10A-10B is a flowchart illustrating backward search in an automated planning system for stream processing workflow composition in accordance with an exemplary embodiment. The process illustrated in FIG. 9 may be implemented in a planner, such as planner 315 in FIG. 3. The process depicted in FIG. 10A-10B is a more detailed description of step 808 in FIG. 8.

Backward search implementation may use a multidimensional data structure to keep track of currently developed solutions during the search. This data structure is called an interval grid. The interval grid may be used to maintain information about the best constructed solution in each of the resource intervals. If the interval grid is not in use, a single feasible solution with the best quality value found during the search is stored. When new solutions are found, their quality is compared to the current best plan, and that plan is replaced by any legal plan that has higher quality. The interval grid is not required, but may be used in a multi-objective case.

The backward search process embodied in FIG. 10A-10B is used to enumerate feasible plans starting from the goal. It follows a branch-and-bound approach of establishing current bounds, and pruning search nodes based on current best solution, however it does not establish bounds by solving linear programs. The process begins as the planner receives preprocessed stream processing planning task definition (step 1002). The preprocessing planning task definition may have been prepared by a step such as preprocessing step 806 of FIG. 8.

Next, the planner creates a new empty partial solution, inserts all task goals into the list of openings, let the list of input candidates in the solution be empty, place the solution on top of the partial solution stack, and reset the list of best solutions (step 1004). Step 1004 allows the planner to start the backward search with an empty partial solution. Next, the planner sets the top partial solution on the stack as the current partial solution (step 1006).

The planner then determines if the list of input candidates is empty (step 1008). If the list of input candidates is empty, the planner determines if the list of open goals is empty (step 1010). The determinations of step 1008 and step 1010 is based on input candidates in the current partial solution. If the list of open goals is empty, the planner determines if the current partial solution is a complete feasible solution (step 1012). The feasibility of the solution may depend upon whether the action is a singleton already used in the partial plan and if the action violates cost bounds. If the solution is a singleton or violates costs bounds, the solution is not feasible. The solution may become infeasible when OR preconditions are not satisfied during connecting a goal to a fully specified stream or when a goal is connected to a partially satisfied stream and a conflict is detected during propagation of preconditions, as described below.

If the current partial solution is a complete feasible solution, the planner creates a candidate solution from the current partial solution (step 1014). The planner updates the list of best solutions using the candidate solution (step 1016). The candidate solution may be registered in the interval grid, or other data structure for maintaining information about developed solutions. Next, the planner removes the partial solution from the top of the stack (step 1018). Step 1018 allows the planner to backtrack to the last partial solution where more than one candidate input existed and to the corresponding list of current goals.

If the current partial solution is not a complete feasible solution in step 1012, the planner removes the partial solution from the top of the stack (step 1018). Next, the planner determines if the stack is empty (step 1020). If the stack is empty the process terminates, if the stack is not empty the planner sets the top partial solution on the stack as the current partial solution.

If the list of open goals is empty in the determination of step 1010, the planner chooses one goal from the list of open goals (step 1022). Next, the planner creates a list of input candidates for satisfying the goal (step 1024). For example, the list may include fully specified streams available in the partial solution, partially specified streams available in the partial solution, and new actions that have candidate outputs matching the input description. Step 1022 and step 1024 are made for the current partial solution. Next, the planner determines if the list of input candidates is empty (step 1008).

If the list of input candidates is not empty in step 1008, the planner selects one of the input candidates and removes it from the list (step 1026). The planner creates a new partial solution derived from the current partial solution (step 1028). Next, the planner categorizes the input candidate (step 1030).

If the input candidate is an action candidate, the planner adds the action candidate to the new partial solution (step 1032). In step 1032 based on the goal connected to the action, the planner computes the modified preconditions of the action. If the planner determines the input candidate is a fully specified stream (step 1030), the planner adds the fully specified stream candidate to the new partial solution (step 1034). In step 1034, the planner may re-evaluate output streams in the partial plan to determine if they become fully specified as a result. As a result of this re-evaluation other streams may become fully specified, and need to be re-evaluated. This procedure is repeated until no more streams may be updated. If after this procedure, the plan no longer satisfies the definition of a legal plan, the solution is labeled as infeasible. If the planner determines the input candidate is a partially specified stream (step 1030), the planner adds the partially specified stream candidate to the new partial solution (step 1036). The planner may propagate back modified preconditions as far as needed in step 1036. For example, inputs of the action producing the partially specified stream may be connected to other actions, and their preconditions need to be re-evaluated as well. If a conflict is detected during the propagation procedure, either because a predicate in the OR group becomes true at output of an action, but is false on all inputs, or because an updated input precondition of an action cannot be satisfied by the stream connected to that precondition, the new partial solution is infeasible. For example, if the plan does not satisfy the definition of a legal plan the new partial solution is infeasible.

Next, the planner removes the satisfied goal from the goal list in the new partial solution (step 1038). The planner then determines if the new partial solution is feasible (step 1040). If the new partial solution is feasible, the planner places the new partial solution on top of the partial solution stack (step 1042) before setting the top partial solution on the stack as the current partial solution (step 1006). If the new partial solution is not feasible in step 1040, the planner determines if the list of input candidates is empty (step 1008).

A number of optimization strategies are implemented in backward search of FIG. 10A-10B to reduce the amount of search node expansions that do not lead to new and better solutions, as well as to reduce the time it takes to process a single goal. An index of all goals that were analyzed in constructing the current partial solution is maintained. In one example, the index may be used to determine whether a solution is feasible in exemplary steps such as step 1012 and step 1040. This allows the planner to avoid symmetry when the same goal is to be reached multiple times within one plan. For example, if there are two goals that are equal, if the goals could be satisfied by actions A and B correspondingly, the actions may be also used in a symmetric way. For example, B and A may be used correspondingly for multiple goals. Symmetry leads to multiple re-evaluation evaluation of the same set of plans. The algorithm avoids this by assigning unique identifying numbers to actions, and ensuring that actions are assigned to goals in non-decreasing order of identifying numbers. Therefore, if B has higher identification number than A, in the previous example the combinations AA, AB, and BB will be possible, but BA will not be considered, because it is symmetric with AB.

A Boolean vector with an element for each of the actions is maintained to track the actions that were used in the current partial solution. The corresponding entry is set to true when the action is used. This allows quick rejection for singleton actions that are already instantiated. The Boolean vector entries may be used in a step such as step 1032.

The candidates for satisfying a goal are sorted by the number of predicates in the goal that they satisfy. While all candidates satisfy all predicates in the CLEAR, AND, and OR groups, the goal may be propagated back to inputs of the action. Heuristic observations are used to infer that in many cases the more predicates are satisfied, the more likely it is that the decision of adding an action will result in a feasible plan. Within the same number of common predicates, the actions are sorted by cost, such that the cheapest actions are considered first.

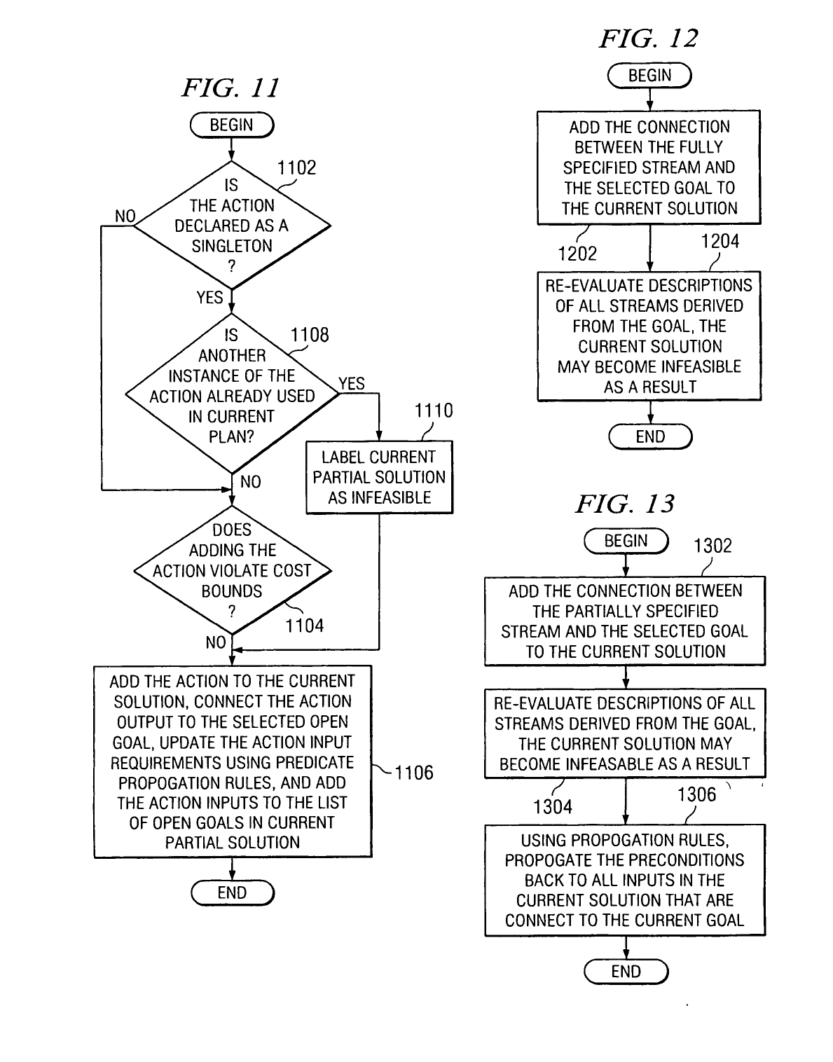

If the optimization or minimization objective is monotone increasing, such that adding new actions to the plan necessarily leads to equal or higher objective value, the search can backtrack when the value of the objective exceeds the current best solution. FIG. 11 is a flowchart for processing candidate inputs that are actions in an automated planning system for stream processing workflow composition in accordance with an exemplary embodiment. The process illustrated in FIG. 11 may be implemented in a planner, such as planner 315 in FIG. 3. The process depicted in FIG. 11 is a more detailed description of step 1032 in FIG. 10B.

The process begins as the planner determines whether the action is declared as a singleton (step 1102). If the action is not declared as a singleton, the planner determines if adding the action violate cost bounds (step 1104). Cost bounds are defined in the :bound vector specified in the stream processing planning language planning problem. If the adding the action does not violate cost bounds, the planner adds the action to the current solution, connects the action output to the selected open goal, updates the action input requirements using predicate propagation rules and adds the action inputs to the list of open goals in the current partial solution (step 1106) with the process terminating thereafter.

If the planner determines that the action is declared as a singleton in step 1102, the planner determines if another instance of the action is already used in the current plan (step 1108). If another instance of the action is not already in use by the current plan, the planner determines if adding the action violates cost bounds (step 1104). If another instance of the action already is in use by the current plan in step 1108, the planner labels the current partial solution as infeasible (step 1110) with the process terminating thereafter. The infeasible label of step 1110 may be used in a feasibility determination such as step 1040 of FIG. 10B.

FIG. 12 is a flowchart for processing candidate inputs that are fully specified streams in an automated planning system for stream processing workflow composition in accordance with an exemplary embodiment.

The process illustrated in FIG. 12 may be implemented in a planner, such as planner 315 in FIG. 3. The process depicted in FIG. 12 is a more detailed description of step 1034 in FIG. 10B.

The process begins as the planner adds the connection between the fully specified stream and the selected goal to the current solution (step 1202). Next, the planner re-evaluates descriptions of all streams derived from the goal, the current solution may become infeasible as a result (step 1204). The process terminates after step 1204.

FIG. 13 is a flowchart for processing candidate inputs that are partially specified stream in an automated planning system for stream processing workflow composition in accordance with an exemplary embodiment. The process illustrated in FIG. 13 may be implemented in a planner, such as planner 315 in FIG. 3. The process depicted in FIG. 13 is a more detailed description of step 1036 in FIG. 10B.

The process begins as the planner adds the connection between the partially specified stream and the selected goal to the current solution (step 1302). Next, the planner re-evaluates descriptions of all streams derived from the goal, the current solution may become infeasible as a result (step 1304). Next, using propagation rules, the planner propagates the preconditions back to all inputs in the current solution that are connected to the current goal (step 1306) with the process terminating thereafter.

The propagation rules require that all AND group predicates that appear in the goal and are not added by the effect of the action port connected to the goal are added to the all preconditions of that action instance. If any of the predicates appear are deleted by the effect of the action port connected to the goal, the propagation terminates, and the current solution is labeled infeasible. Similarly, if the port carries a fully specified stream, if the stream description does not contain all predicates required in the goal, the current solution is labeled infeasible and propagation is terminated. The propagation procedure is repeated for all action ports that are connected to the preconditions of the action instance connected to the goal, with the preconditions used in place of the goal in propagation. If any of the preconditions of action instances are changed as a result, the procedure is repeated for those preconditions, until there are no more preconditions that must be updated according to this rule.

Embodiments of the present invention provide a method for automatic planning in a stream processing environment. The described search method achieves significantly improved scalability compared to other planning methods, when applied to stream processing planning problems.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing automatic planning in a compositional system, the method comprising:
responsive to receiving a planning language input, performing parameter substitution;
responsive to performing parameter substitution, preprocessing actions; and
responsive to preprocessing actions, performing a backward search for potential solutions,
wherein a domain description is used for performing parameter substitution, preprocessing, and performing a backward search;
wherein the planning language input specifies at least one goal and at least one action;
wherein a description of an action includes at least one description of action preconditions and at least one description of action effects;
wherein the action preconditions include predicates that must hold on input streams connected to the action in a valid workflow; and
wherein the action effects include creation of new streams that include an action output and wherein the description of the action effects include information for computing predicates on output streams given predicates on input streams.

2. The method of claim 1, wherein the preprocessing step further comprises:
grouping actions into super-actions; and
representing elements of the planning problem.

3. The method of claim 2, wherein the preprocessing step further comprises:
indexing the action preconditions and the action effects.

4. The method of claim 3, wherein the preprocessing step further comprises:
forward propagation of singleton flags; and
performing a connectivity check.

5. The method of claim 1, further comprising:
parsing the planning language input based on an object hierarchy to create a domain description and a problem description.

6. The method of claim 1, wherein the searching step further comprises:
creating partial solutions wherein action instances are interconnected and the action instances are connected to a set of goals.

7. The method of claim 6, wherein the searching step further comprises:
creating a new partial solution based on an existing partial solution by adding streams connecting at least one input candidate to one or more open goals in the existing partial solution.

8. The method of claim 7, wherein the at least one input candidate comprises outputs of actions instances included in the partial solutions.

9. The method of claim 6, wherein the at least one input candidates comprise outputs of the action instances, wherein inputs of actions become the open goals in the new partial solution.

10. The method of claim 6, wherein the at least one input candidates comprise primal streams in an initial state.

11. The method of claim 6, further comprising:
identifying at least one input candidates using an index of compatible input ports and output ports of the actions.

12. The method of claim 11, wherein the at least one input candidates are rejected if new action instances are instances of actions that are already used in the partial solution and identified as singletons during forward propagation of singleton flags before planning.

13. The method of claim 6, wherein efficient representation of a stream state is used to describe open goals, inputs of action instances, and outputs of action instances.

14. The method of claim 1, further comprising:
grouping actions into super-actions before planning to combine actions the same input port descriptions and output port descriptions; and
using multiple choice knapsack problem solution methods after planning to determine an exact choice of an action instance of which used in place of super-action instance in a final plan.

15. The method of claim 1, wherein the planning language is a stream processing planning language, and wherein the compositional system is any of a grid system and a Web services system.

16. An automatic planning system for stream processing comprising:
a stream processing operating environment;
a controller configured to receive a request for stream processing;
a translation service configured to translate the request for stream processing into a formal expression of the request in a description language; and
a planning library configured to generate a workflow based on the formal expression of the request and a domain definition in the description language, wherein the domain definition describes the stream processing operating environment, and wherein the workflow comprises nodes corresponding to stream processing application components with possible parameters values set and links corresponding to streams, wherein the planning library parses a description language input, performs parameter substitution, preprocesses actions, and searches backward for potential solutions, wherein the planning language input specifies at least one goal and at least one action, wherein a description of an action includes at least one description of action preconditions and at least one description of action effects, wherein the action preconditions include predicates that must hold on input streams connected to the action in a valid workflow; and wherein the action effects include creation of new streams that include an action output and wherein the description of the action effects include information for computing predicates on output streams given predicates on input streams.

17. The automatic planning system for stream processing of claim 16, wherein the stream processing operating environment is any of a web service stream processing operating environment and a grid stream processing operating environment.

18. The automatic planning system of claim 16, wherein the automatic planning system performs automatic replanning by adapting to changes in an operating environment by generating new plans for deployed jobs already deployed when changes invalidate previously planned workflows for the deployed jobs, and wherein the planning library creates an index of action preconditions and action effects while preprocessing actions.

19. The automatic planning system of claim 16, wherein the automatic planning system is an automatic planning system for web services and further comprises:
an access interface and protocol for accessing a web services execution environment using a network;
wherein the controller, the translation service, and the planning library are configured to function in the web services execution environment.

20. A computer program product comprising a computer usable medium including computer usable program code for performing automatic planning in a compositional system, said computer program product including:
computer usable program code responsive to receiving a planning language input, for performing parameter substitution;
computer usable program code responsive to performing parameter substitution, for preprocessing actions, wherein an index of action preconditions and action effects is created; and
computer usable program code responsive to preprocessing actions, for performing a backward search for potential solutions,
wherein a domain description is used for performing parameter substitution, preprocessing, and performing a backward search, wherein actions within the domain description have one or more input and one or more output, wherein the planning language input specifies at least one goal and at least one action, wherein a description of an action includes at least one description of action preconditions and at least one description of action effects, wherein the action preconditions include predicates that must hold on input streams connected to the action in a valid workflow; and wherein the action effects include creation of new streams that include an action output and wherein the description of the action effects include information for computing predicates on output streams given predicates on input streams.
